(19) United States
(12) Patent Application Publication
(10) Pub. No.: US 2023/0271524 A1
(43) Pub. Date: Aug. 31, 2023

(54) ELECTRIC VEHICLE CHARGING SYSTEMS AND METHODS

(71) Applicant: Georgia Tech Research Corporation, Atlanta, GA (US)

(72) Inventors: Shreyas B. Kulkarni, Atlanta, GA (US); Rajendra Prasad Kandula, Atlanta, GA (US); Deepakraj M. Divan, Atlanta, GA (US)

(21) Appl. No.: 18/010,925

(22) PCT Filed: Jun. 18, 2021
(86) PCT No.: PCT/US2021/038042

§ 371 Date: Dec. 16, 2022

Related U.S. Application Data
(60) Provisional application No. 63/041,631, filed on Jun. 19, 2020.

(51) Int. Cl. B60L 53/63; H02J 7/00; H02J 7/04

(52) U.S. Cl. CPC B60L 53/63; H02J 7/04; H02J 7/0047; B60L 2210/30; H02J 2310/48

(57) ABSTRACT

An exemplary embodiment of the present disclosure provides a method for charging electric vehicles using service transformers on an electric utility grid. The method can comprise monitoring one or more electrical and/or thermal properties of a plurality of service transformers on an electric utility grid, and based on the monitored one or more electrical and/or thermal properties, determining that one or more of the plurality of service transformers have capacity to charge an electric vehicle.

### CROSS-REFERENCE TO RELATED APPLICATIONS

This application claims the benefit of U.S. Provisional Application Serial No. 63/041,631, filed on 19 Jun. 2020, which is incorporated herein by reference in its entirety as if fully set forth below.

### FIELD OF THE DISCLOSURE

The various embodiments of the present disclosure relate generally to systems and methods for charging electric vehicles, and more particularly to systems of methods of using electric utility service transformers to charge electric vehicles.

### BACKGROUND

Electric vehicles (EVs) are rapidly proliferating, driven in part by their low energy, operating and maintenance costs, as well as by the long-projected life for the batteries and vehicles. This is also triggering demand for use by a wide cross-section of society, as well as in applications such as delivery, ride-share, and taxis. The traditional view for EV charging has been that it will largely be done using Level-2 charging in residential garages for 6-8 hours per day, with only occasional use of fast charging when long trips are required. With broader deployment, however, this view is being challenged. Many of the new potential EV users do not have garages as they live in apartments or otherwise do not have access to a secured charging facility where they can remain connected for long durations. Yet, the low cost of EVs makes it very interesting and affordable as a transportation alternative, even to the poorest cross-section of society. There is need for ubiquitous EV fast charging infrastructure that allows charging over much smaller time scales, eventually approaching 10-20 minutes. This fast charging infrastructure has to be established before consumers will feel comfortable purchasing EVs at large scale. Estimates for EVs in the US range as high as 80-170 million, or 50% of all vehicles, by 2040, although that number today is still <1 million.

EV fast charging today is typically done using DC power at 25-250 kW, with fast charging for electric semis estimated to reach 1.5 - 4.5 MW. Several EV manufacturers, such as Tesla and Volkswagen, as well as utilities and other private companies are rolling out DC fast chargers across the nation in key urban areas, or along high traffic corridors. But this may not reach the level of coverage needed to encourage broad deployment. Even as DC fast charging stations are being deployed, serious concerns are emerging. Even 10 million (6-8% of EVs by 2040) vehicles charging at 100 kW each represents 1000 GW-the total electrical generation capacity of the entire country. This would present a challenge to the utilities if EV charging is done without coordination with available capacity (a situation that becomes even more complex as utilities move towards higher variability renewable generation such as photovoltaic solar).

The second challenge comes from the high cost of installing and operating a DC fast charging station. A typical 100 kW DC fast charger is estimated to cost between $30,000-60,000, plus land, permitting, civil, and operational costs. These costs need to be recovered from EVs that charge at the facility. In addition, monthly charges paid to the electric utility include demand charges and energy charges (plus costs to build service to the facility). Demand charges range from $5-25/kW/month and can be a very high component of the total costs paid by EV owners. In the early years, when few EVs will use the facility (except for high-traffic urban areas), the high costs make a viable business model very challenging. If this problem is not solved, broad deployment of EVs may not occur. Assuming 100 million EVs by 2040 that need fast charging, and assuming each fast charging station services 10 EVs/day, it is likely that as many as 3-5 million fast charging outlets may be required within 20 years - representing a $300-500 Billion investment with the current approach. Accordingly, a new approach is needed.

It should be understood that while peak loading of the grid is a problem, the amount of energy used to charge 100 million EVs represents only 4% of energy used in the US today, and is not an issue. What is desirable for broad deployment is an approach that dramatically reduces the first cost and operating cost of fast charging. Secondly, it is desirable to deploy these chargers ubiquitously in both urban and rural areas. Thirdly, it is desirable to optimally use the infrastructure such that multiple value streams are captured, reducing the cost of delivering the service.

Utilities serve their customers from the medium voltage distribution grid using service transformers, that typically step down the voltage from 13 kV to 240 volts (single phase) or 480 volts (3 phase). These service transformers are typically rated at 15 kVA to 75 kVA for single phase service, to as high as 5 MW for 3 phase service. These transformers represent a “sunk” investment for the utilities, and have been coordinated through an integrated planning process to ensure that wires, switchgear, protection, and generation are available to service the peak loads at the point of service. Customers are “metered” for the electricity consumed using meters. Service transformers are located anywhere and everywhere electricity is available, and represent a ubiquitous resource.

The vast majority of transformers operate at well below maximum capacity for a large part of the day. Given that utilities had no visibility or control over the transformer, or the load, this was a preferred way to design and operate the distribution system. This also gave the possibility that the load could be increased over time. The transformers were designed for long life (30-50 years), typically requiring a cool down period so that “hot-spot” temperatures inside the transformer remained in safe limits. Again, given no visibility, designs were very conservative (confirmed by the fact that 30-year life transformers routinely survive to 50 \+ years and beyond). This suggests that utility transformers may represent a vast under-utilized resource. The challenge is that today no one, including the utility, has any idea as to which transformers have spare capacity, and when that capacity can be used for other purposes.

The third piece of this puzzle touches on the EV and the form in which it consumes the electricity for fast charging. The lowest cost of service point is similar to Level 2 charging-the provision of 3-phase power at a power level of 25 kW to 100 kW (or more). This would then require an on-vehicle fast charger, which is not the norm today (although some argue it should be). In terms of rolling out fast charging infrastructure, this could provide the lowest cost alternative. Based on current trends, the preferred alternative is DC fast charging at a voltage level of 400 volts (growing to 800 volts for EVs) and power levels of 25-250 kW. While earlier fast chargers used unidirectional converters, more recent designs are using active front-ends to ensure low harmonics, and the eventual possibility of “vehicle to grid” or V2G power flow control. Newer converter designs, such as the soft switching solid state transformer (S4T), offer the possibility that such functionality can be integrated in a compact and inexpensive charging portal that can be widely deployed.

Accordingly, there is a need for improved systems and methods for charging EVs that address one or more of the issues discussed above.

### BRIEF SUMMARY

The present disclosure relates to EV charging systems and methods. An exemplary embodiment of the present disclosure provides a method for charging EVs using service transformers on an electric utility grid. The method can comprise monitoring one or more electrical and/or thermal properties of a plurality of service transformers on an electric utility grid, and based on the monitored one or more electrical and/or thermal properties, determining that one or more of the plurality of service transformers have capacity to charge an EV.

In any of the embodiments disclosed herein, the one or more electrical and/or thermal properties can comprise one or more measurements of power output, current output, voltage output, ambient transformer temperature, transformer tank temperature, and internal transformer temperature.

In any of the embodiments disclosed herein, monitoring the one or more electrical and/or thermal properties can comprise using one or more sensors located proximate the plurality of service transformers.

In any of the embodiments disclosed herein, determining that the one or more of the plurality of service transformers have capacity to charge an EV can comprise determining an available charging rate associated with the one or more of the plurality of service transformers.

In any of the embodiments disclosed herein, the available charging rate can be determined in kilowatts.

In any of the embodiments disclosed herein, monitoring the one or more electrical and/or thermal properties of the plurality of services transformers on an electric utility grid can comprise storing historically measured data of the one or more electrical and/or thermal properties of the plurality of service transformers.

In any of the embodiments disclosed herein, determining that one or more of the plurality of service transformers have capacity to charge an EV can comprise analyzing the historically measured data and real-time measured data of the one or more electrical and/or thermal properties of the plurality of service transformers.

In any of the embodiments disclosed herein, determining that one or more of the plurality of service transformers have capacity to charge an EV can comprise determining that the one or more of the plurality of service transformers have capacity to charge an EV over a predetermined upcoming time interval.

In any of the embodiments disclosed herein, the method can further comprise generating a map with location information for EV charging stations associated with the one or more of the plurality of service transformers having capacity to charge an EV.

In any of the embodiments disclosed herein, the method can further comprise transmitting the map to a plurality of EVs.

In any of the embodiments disclosed herein, monitoring one or more electrical and/or thermal properties of a plurality of service transformers can comprise receiving information transmitted by one or more sensors corresponding to the plurality of service transformers.

In any of the embodiments disclosed herein, the method can further comprise receiving charging requirements from one or more EVs, and wherein determining that one or more of the plurality of service transformers have capacity to charge an EV is further based on the received charging requirements from the one or more EVs.

In any of the embodiments disclosed herein, the method can further comprise transmitting available charging information to a first EV in the one or more EVs, the available charging information comprising a location of the one or more of the service transformers determined to have capacity to charge the first EV.

In any of the embodiments disclosed herein, the method can further comprise receiving present location information of the one or more EVs, wherein determining that one or more of the plurality of service transformers have capacity to charge an EV is further based on the current location information of the one or more EVs.

In any of the embodiments disclosed herein, the available charging information can further comprise a charging rate of the one or more of the service transformers determined to have capacity to charge the first EV.

Another embodiment of the present disclosure provide an EV charging system. The system can comprise a power input, a power output, one or more sensors, a processor, and a memory. The power input can be configured to receive electrical power from a service transformer connected to an electric utility grid. The power output can be configured to provide electrical power to an EV to charge the EV. The one or more sensors can be configured to monitor one or more electrical and/or thermal properties of the service transformer. The memory can comprise instructions that, when executed by the processor, cause the processor to determine, based on the one or more electrical and/or thermal properties, whether the service transformer has available capacity to charge an EV.

In any of the embodiments disclosed herein, the one or more electrical and/or thermal properties can comprise one or more of power output, current output, voltage output, ambient transformer temperature, transformer tank temperature, and internal transformer temperature.

In any of the embodiments disclosed herein, the one or more electrical and/or thermal properties can comprise power output, current output, voltage output, ambient transformer temperature, transformer tank temperature, and internal transformer temperature.

In any of the embodiments disclosed herein, the memory can further comprise instructions that, when executed by the processor, cause the processor to determine an available charging rate associated with the service transformer.

In any of the embodiments disclosed herein, at least one of the memory and the one or more sensors can be configured to store historically measured data of the one or more electrical and/or thermal properties of the service transformer.

In any of the embodiments disclosed herein, the memory can further comprise instructions that, when executed by the processor, cause the processor to determine, based on the one or more electrical and/or thermal properties, whether the service transformer has available capacity to charge an EV by analyzing the historically measured data and real-time measured data of the one or more electrical and/or thermal properties of the service transformer.

In any of the embodiments disclosed herein, the memory can further comprise instructions that, when executed by the processor, cause the processor to determine, based on the one or more electrical and/or thermal properties, whether the service transformer has available capacity to charge an EV over a predetermined upcoming time interval.

In any of the embodiments disclosed herein, the power input can be configured to receive electrical power from the service transformer at a voltage level of about 120 volts.

In any of the embodiments disclosed herein, the power input can be configured to receive electrical power from the service transformer at a voltage level of about 480 volts.

In any of the embodiments disclosed herein, the power input can be configured to receive electrical power from the service transformer at a voltage level of about 208 volts.

In any of the embodiments disclosed herein, the power input can be configured to receive electrical power from the service transformer at a voltage level of about 240 volts.

In any of the embodiments disclosed herein, the system can further comprise an alternating current to direct current converter, wherein the power output is configured to provide direct current electrical power to the EV.

In any of the embodiments disclosed herein, the system can be further configured to receive electrical power from an EV and provide electrical power to the electric utility grid.

In any of the embodiments disclosed herein, the system can further comprise a transceiver. The transceiver can be configured to transmit information to a cloud-based network, the information indicative of whether the service transformer has available capacity to charge an EV.

In any of the embodiments disclosed herein, the information can be further indicative of an available charging rate associated with the service transformer.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides an EV charging system, in accordance with an embodiment of the disclosure.

FIG. 2 provides a transformer sensing subsystem, in accordance with an embodiment of the disclosure.

FIG. 3A provides a system level view of an EV charging system, in which the power input of the EV charging subsystem is configured to receive three-phase 480 VAC power and the power output of the EV charging subsystem is configured to output 400-800 VDC power, in accordance with an embodiment of the disclosure.

FIG. 3B provides a system level view of an EV charging system, in which the power input of the EV charging subsystem is configured to receive single-phase 240 VAC power and the power output of the EV charging subsystem is configured to output 240 VAC power, in accordance with an embodiment of the disclosure

FIG. 4 provides an AC-DC bidirectional power converter, in accordance with an embodiment of the disclosure.

### DETAILED DESCRIPTION

To facilitate an understanding of the principles and features of the present invention, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

The present disclosure relates to EV charging systems and methods that make use of available charging capacity in currently deployed service transformers. As used herein, the term “service transformer” refers to a step-down electric power transformer that is directly connected to an electric utility power distribution grid and used to provide electrical power service to one or more customers. Service transformers are typically either pole-mounted or pad-mounted and can provide either single- or three-phase alternating current power.

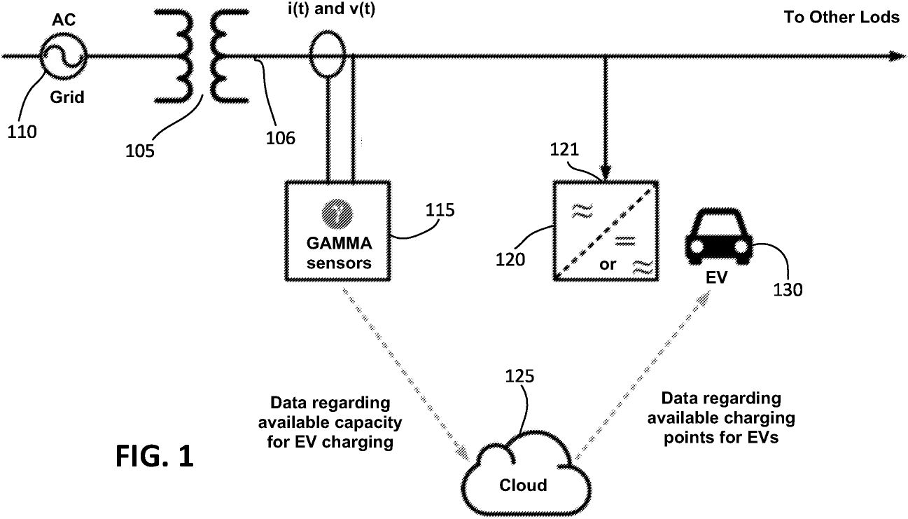

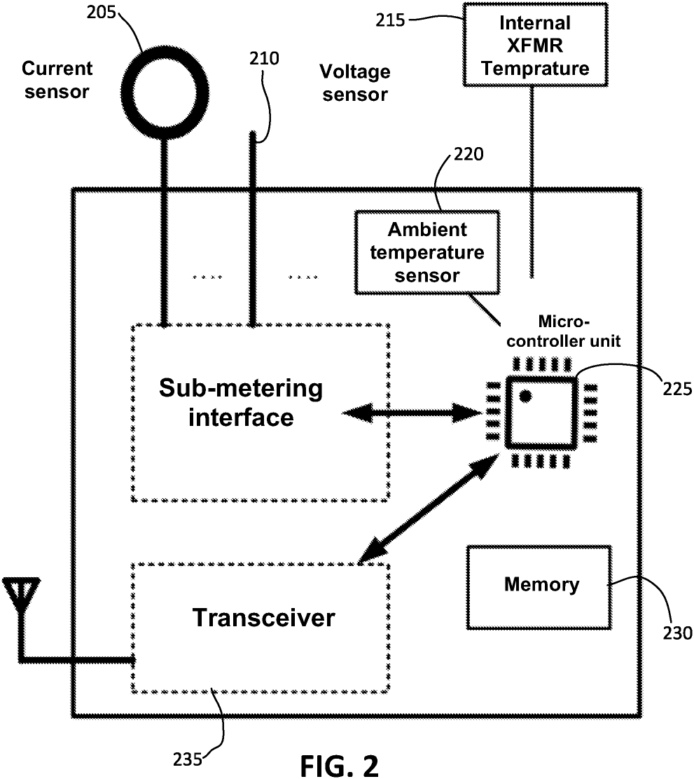

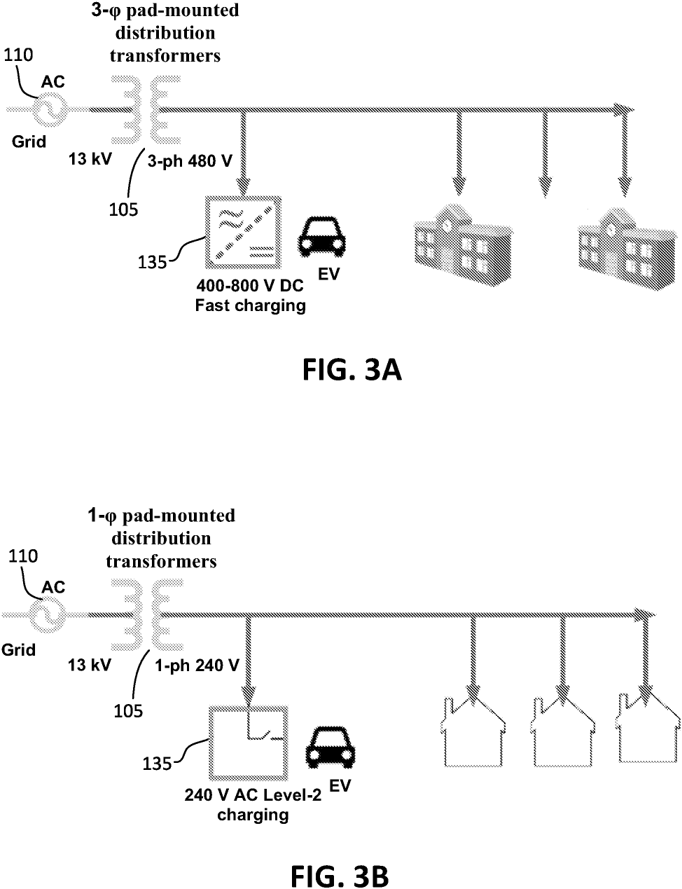

As shown in FIG. 1, an exemplary embodiment of the present disclosure provides an EV charging system 135. The system 135 can comprise a transformer sensing subsystem 115 and a EV charging subsystem 120. As discussed in more detail below, the transformer sensor subsystem 115 can generally monitor (e.g., measure or receive measurements of) one or more electrical and/or thermal properties of the service transformer 105 to determine if the service transformer 105 has available capacity to charge an EV 130. As also discussed in more detail below, the EV charging system can generally receive electric power from the service transformer 105 and provide the electric power to a EV 130 for charging the EV 130.

The charging subsystem 120 can comprise a power input 121 and a power output 122. The power input 121 can be configured to receive electrical power from a service transformer 105 connected to an electric utility grid 110. The received electrical power is typically alternating current power, though the present disclosure is not so limited. The voltage level of the power received by the power input 121 can be many different voltages, e.g., 120 V or 480 V. Additionally, the power input 121 can receive either single-phase or three-phase power. The power output 122 can be configured to connect to a charging port of an EV 130 to provide electrical power to the EV 130 for charging the EV 130. The electrical power provided to the EV 130 can be either AC or DC power.

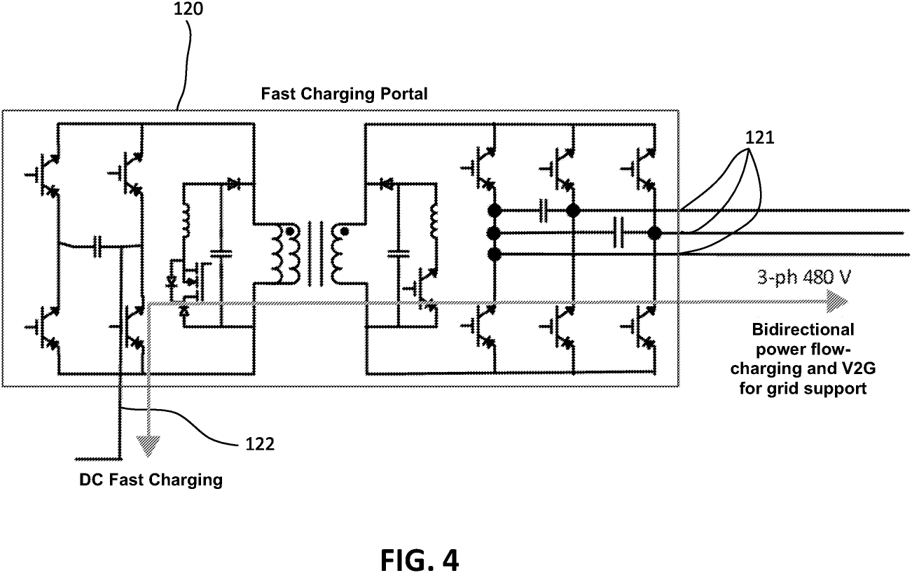

In some embodiments where the input power received by the charging subsystem 120 is AC power and the power provided to the EV 130 by the power output 122 is DC power, the charging subsystem 120 can further comprise an AC-DC power converter. The AC-DC power converter can be many different AC-DC power converters known in the art. FIG. 4 provides an exemplary AC-DC 3-phase power converter that can be included with the charging subsystem 120, in accordance with some embodiments of the present disclosure. As shown in FIG. 4, the AC-DC power converter includes a power input 121 configured to receive 3-phase AC power from a service transformer 105 and a power output 122 configured to deliver DC power to the EV 130.

In some embodiments of the present disclosure, the charging subsystem 120 allows for bi-directional power flow, such that power the charging subsystem 120 can receive electrical power from an EV 130 and provide the received electrical power to the utility grid 110. For example, as shown in FIG. 4, the power input 121 can receive power from the electric utility grid 110 (via the service transformer 105) while the power output 122 provided the received power to the EV 130, and the power output 122 can receive electric power from the EV 130 while the power input 121 provides the received power to the electric utility grid 110. Thus, when useful, the utility grid operator(s) can use electric power stored in one or more EVs to supplement the capacity of the electric utility grid 110.

As discussed above, the EV charging system 135 can further comprise a transformer sensing subsystem 115. The transformer sensing subsystem 115 can comprise one or more sensors 205, 210, 215, 220 configured to monitor one or more electrical and/or thermal properties of the service transformer 105. In some embodiments, the one or more sensors 205, 210, 215, 220 can be configured to monitor both electrical and thermal properties of the service transformer 105. The one or more sensors 205, 210, 215, 220 can be many different sensors known in the art. In some embodiments, the one or more sensors 205, 210, 215, 220 can comprise one or more of current sensors 205, voltage sensors 210, power sensors (not shown), and temperature sensors 215, 220. In some embodiments, the one or more sensors 205, 210, 215, 220 can comprise one or more sensors employing a Rogowski coil, such as those sensors disclosed in PCT Publication NO. WO2021/021889, entitled “Current Sensors Employing Rogowski Coils and Methods of Using Same,” which is incorporated herein by reference in its entirety.

The one or more electrical and/or thermal properties monitored by the one or more sensors 205, 210, 215, 220 can comprise one or more of the service transformer power output, the service transformer current output, the service transformer voltage output, the service transformer internal temperature, the service transformer tank temperature, and the ambient temperature at the service transformer 105. As used herein, the “output” of the service transformer 105 is the low voltage side 106 of the service transformer 105 (as shown in FIG. 1). In some embodiments, the one or more sensors 205, 210, 215, 220 can monitor each of the service transformer power output, the service transformer current output, the service transformer voltage output, the service transformer internal temperature, the service transformer tank temperature, and the ambient temperature at the service transformer 105.

The transformer sensing subsystem 115 can further comprise a processor 225 and memory 230. The processor 225 can be many processors known in the art. In some embodiments, the processor 225 is a microcontroller. The memory 230 can be many different memories known in the art. The memory 230 can store instructions that, when executed by the processor 225, cause the processor 225 to perform various functions associated with the transformer sensing subsystem 115. The processor 225 can receive data from the one or more sensors 205, 210, 215, 220 indicative of the one or more electrical and/or thermal properties monitored by the one or more sensors 205, 210, 215, 220. This data can be stored in the memory 230. Based on the one or more electrical and/or thermal properties, the processor 225 can determine whether the service transformer 105 has available capacity to charge an EV 130.

In some embodiments, the memory 230 can further comprise instructions that, when executed by the processor 225, cause the processor 225 to determine an available charging rate associated with the service transformer 105. This determination can also be made based, at least in part on the measured one or more electrical and/or thermal properties of the service transformer 105. The charging rate can be determined in kilowatts.

In some embodiments, the memory 230 and/or the one or more sensors 205, 210, 215, 220 can be configured to store historically measured data of the one or more electrical and/or thermal properties of the service transformer 105. In some embodiments, a determination as to whether the service transformer 105 has available capacity to charge an EV 130 can be based at least in part by analyzing the historically measured data and real-time measured data of the one or more electrical and/or thermal properties of the service transformer 105. In some embodiments, the historically measured data and real-time measured data can be used to determine whether the service transformer 105 has available capacity to charge an EV 130 over a predetermined upcoming time interval. In other words, the historic and real-time data can be used to make a prediction of whether the service transformer 105 will have available capacity to charge an EV 130 over a predetermined upcoming time interval.

In some embodiments, the transformer sensing subsystem 115 can comprise a transceiver 235. The transceiver 235 can be configured to transmit information to a cloud-based network 125. The transmission can occur via any wired or wireless communication means known in the art. In some embodiments, the information can be indicative of whether the service transformer 105 has available capacity to charge an EV 130. In some embodiments, the information can be further indicative of an available charging rate associated with the service transformer 105.

In some embodiments, the transformer sensing subsystem 115 can be configured to monitor the one or more electrical and/or thermal properties of the service transformer 105 and transmit that information via the transceiver 135 to a remote computer (not shown), e.g., over the cloud-based network 125. For example, the transformer sensing subsystem 115 can comprise the one or more sensors 205, 210, 215, 220 and can transmit the measurements on the one or more electrical and/or thermal properties of the service transformer 105 to the remote computer. The remote computer can receive the information transmitted by the transformer sensing subsystem 115 corresponding to service transformer 105. The remote computer can then make the determination as to whether the service transformer 105 has available capacity to charge an EV 130. In some embodiments, the remote computer (or a plurality of remote computers can receive information from a plurality of transformer sensing subsystems 115 associated with a plurality of corresponding service transformers 105 and determine whether each of the plurality of service transformers 105 has available capacity to charge an EV 130 over a upcoming time interval.

In some embodiments, the one or more remote computers (and/or the transformer sensing subsystem 115) can further receive charging requirements from the one or more EVs. The charging requirements can include information on the present battery state of the charge of the EV 130 and/or the battery charging requirements of the EV 130 in terms of voltage, current, and desired charge level on the battery. The determination of whether service transformers 105 have the ability to charge EVs can further be based on the received charging requirements for the respective EVs.

In some embodiments, one or more remote computers (and/or the transformer sensing subsystem 115) can further receive present location information of the one or more EVs. The determination of whether service transformers 105 have the ability to charge EVs can further be based on the received present location information of the one or more EVs.

In some embodiments, the one or more remote computers can generate a map with location information of the EV charging stations associated with the one or more of the plurality of service transformers 105 having capacity to charge an EV 130. In some embodiments, this map can then be transmitted to one or more EVs, e.g., over a cloud-based network 125, thus providing those EVs with the location information for service transformers 105 capable of charging the EVs. As used herein, the term “cloud-based network” includes any combination of wired and wireless networks allowing remote devices to communicate with each other, including over the Internet.

In some embodiments, the one or more remote computers (and/or the transformer sensing subsystem 115) can transmit available charging information to one or more EVs. In some embodiments, the available charging information can comprise a location of one or more of the service transformers 105 determined to have capacity to charge the one or more EVs. In some embodiments, the available charging information can comprise a charging rate of the one or more of the service transformers 105 determined to have capacity to charge the one or more EVs.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method comprising:
monitoring one or more electrical and/or thermal properties of service transformers on an electric utility grid; and
determining if one or more of the service transformers have capacity to charge an electric vehicle.

2. (canceled)

3. The method of claim 1, wherein the monitoring comprises using one or more sensors located proximate at least a portion of the service transformers;
wherein the determining is based on the monitoring; and
wherein at least one of the electrical and/or thermal properties is a measurement of a property selected from the group consisting of power output, current output, voltage output, ambient transformer temperature, transformer tank temperature, and internal transformer temperature.

4. The method of claim 3, wherein the determining comprises determining an available charging rate associated with at least a portion of the service transformers.

5. The method of claim 4, wherein the available charging rate is determined in kilowatts.

6. The method of claim 3 further comprising:
receiving electrical power from at least one of the service transformers via a power input; and
converting the electrical power from alternating current to direct current;
wherein the monitoring comprises storing historically measured data of one or more of the electrical and/or thermal properties ; and
wherein the power input is configured to receive the electrical power at a voltage level selected from the group consisting of about 120 volts, about 208 volts, about 240 volts, about 480 volts, and combinations thereof.

7. The method of claim 6, wherein the determining comprises analyzing the historically measured data and real-time measured data.

8. The method of claim 3, wherein the determining comprises determining if one or more of the service transformers have capacity to charge an electric vehicle over a predetermined upcoming time interval.

9. The method of claim 3 further comprising:
generating a map with location information for electric vehicle charging stations associated with the service transformers determined to have capacity to charge an electric vehicle; and
transmitting the map to one or more electric vehicles.

10. (canceled)

11. The method of claim 3, wherein the monitoring comprises receiving charging information transmitted by one or more of the sensors.

12. The method of claim 3 further comprising receiving charging requirements from one or more electric vehicles;
wherein the determining is further based on the received charging requirements.

13. A method comprising:
monitoring one or more electrical and/or thermal properties of service transformers on an electric utility grid;
receiving charging requirements from an electric vehicle;
based on the monitoring and the receiving, determining if one or more of the service transformers have capacity to charge the electric vehicle; and
transmitting available charging information to the electric vehicle, the available charging information comprising location data of one or more electric vehicle charging stations associated with one or more of the service transformers determined to have capacity to charge the electric vehicle.

14. The method of claim 13 further comprising receiving current location information of the electric vehicle;
wherein the determining is further based on the current location information.

15. The method of claim 13, wherein the available charging information further comprises a charging rate of one or more of the service transformers determined to have capacity to charge the electric vehicle.

16. An electric vehicle charging system configured to implement the method of claim 13 comprising:
a power input configured to receive electrical power from one of the service transformers;
a power output configured to provide electrical power to the electric vehicle to charge the electric vehicle;
a receiver configured to receive the charging requirements from the electric vehicle;
a transmitter configured to transmit the available charging information to the electric vehicle;
one or more sensors configured for the monitoring of the one or more electrical and/or thermal properties of the service transformer;
a processor; and
memory, the memory comprising instructions that, when executed by the processor, cause the processor to:
determine, based on one or more electrical and/or thermal properties and the charging requirements, whether the service transformer has available capacity to charge the electric vehicle.

17. The electric vehicle charging system of claim 16, wherein the receiver and the transmitter comprise a transceiver; and
wherein one or more of the electrical and/or thermal properties is a measurement of a property selected from the group consisting of power output, current output, voltage output, ambient transformer temperature, transformer tank temperature, and internal transformer temperature.

18. (canceled)

19. The electric vehicle charging system of claim 16, wherein the memory further comprises instructions that, when executed by the processor, cause the processor to determine an available charging rate associated with the service transformer.

20. The electric vehicle charging system of claim 16, wherein the charging rate is determined in kilowatts.

21. The electric vehicle charging system of claim 16, wherein at least one of the memory and the one or more sensors are configured to store historically measured data of the one or more electrical and/or thermal properties of the service transformer.

22. The electric vehicle charging system of claim 21, wherein the memory further comprises instructions that, when executed by the processor, cause the processor to determine, based on the one or more electrical and/or thermal properties and the charging requirements, whether the service transformer has available capacity to charge the electric vehicle by analyzing the historically measured data and real-time measured data of one or more electrical and/or thermal properties of the service transformer.

23. The electric vehicle charging system of claim 16, wherein the memory further comprises instructions that, when executed by the processor, cause the processor to determine, based on the one or more electrical and/or thermal properties and the charging requirements, whether the service transformer has available capacity to charge the electric vehicle over a predetermined upcoming time interval.

24. The electric vehicle charging system of claim 16, wherein the power input is configured to receive the electrical power from the service transformer at a voltage level selected from the group consisting of about 120 volts, about 208 volts, about 240 volts, about 480 volts, and combinations thereof.

25-27. (canceled)

28. The electric vehicle charging system of claim 16 further comprising an alternating current to direct current converter;
wherein the power output is configured to provide direct current electrical power to the electric vehicle.

29. The electric vehicle charging system of claim 16, wherein the system is further configured to receive electrical power from another electric vehicle and provide electrical power to the electric utility grid.

30. The electric vehicle charging system of claim 16, wherein the transmitter is configured to transmit the available charging information to a cloud-based network.

31. (canceled)
